(19) United States
(12) Patent Application Publication
(10) Pub. No.: US 2011/0264842 A1
(43) Pub. Date: Oct. 27, 2011

(54) MEMORY CONTROLLER, NONVOLATILE MEMORY DEVICE, ACCESS DEVICE, AND NONVOLATILE MEMORY SYSTEM

(76) Inventors: Masahiro Nakanishi, Kyoto (JP); Takuji Maeda, Osaka (JP)

(21) Appl. No.: 12/527,882

(22) PCT Filed: Jun. 12, 2008
(86) PCT No.: PCT/JP2008/001501

§ 371 Date: Aug. 20, 2009

(30) Foreign Application Priority Data
Jun. 22, 2007 (JP) 2007-165384

(51) Int. Cl. G06F 12/02

(52) U.S. Cl. 711/103; 711/E12.008

(57) ABSTRACT

A lifetime parameter generation part 128 generates a lifetime parameter related to a lifetime of a nonvolatile memory device 110. When the remaining lifetime has become short, a mode switching part 129 switches a read-write mode of a read-write control part 124 from a rewritable mode to a write once mode and notifies an access device 100 that the mode has been switched to the write once mode. Thus, a user can easily recognize the moment when an apparatus having the built-in nonvolatile memory cannot be used, and, immediately before the lifetime is over, the mode can be automatically switched to the write once mode in which writing can be carried out only once.

### TECHNICAL FIELD

The present invention relates to a nonvolatile memory device such as a semiconductor memory card having a nonvolatile memory, a memory controller for controlling said nonvolatile memory, an access device for accessing said nonvolatile memory device, and a nonvolatile memory system configured by adding the access device as a component to said nonvolatile memory device.

### BACKGROUND ART

A nonvolatile memory device having a rewritable nonvolatile memory is increasingly demanded mainly for a semiconductor memory card. The semiconductor memory card is very high-price compared to an optical disk, a tape media, and the like, however, the semiconductor memory card is increasingly demanded as a memory medium for a portable apparatus such as a digital still camera and a mobile phone because of merits such as small-size, lightweight, vibration resistance, and easy handling. This semiconductor memory card includes a flash memory as a nonvolatile main memory, and has a memory controller for controlling the memory. The memory controller carries out the reading and writing control to the flash memory in accordance with a reading or writing command from an access device such as the digital still camera and a personal computer. In addition, there is a portable audio apparatus not only using the semiconductor memory card as a memory device but also mounting the flash memory inside the portable audio apparatus. In these years, the semiconductor memory card is used not only for such consumer use but also for a professional-use moving image recording apparatus, for example, for a broadcast station.

Since the flash memory incorporated in a product such as the semiconductor memory card and the portable audio apparatus requires relatively long time to write and erase data to and from a memory cell array that is a recording unit, the flash memory employs a constitution to enable data to be collectively erased and written from and to a plurality of memory cells. Specifically, the flash memory is composed of a plurality of physical blocks and each physical block includes a plurality of pages. The erasing is carried out in units of physical blocks and the writing is carried out in units of pages.

In these years, to satisfy demands for a high capacity and a low cost, a main type of the flash memory is able to store 2-bit data in one memory cell such as a multi-level NAND flash memory. Such multi-level NAND flash memory is hard to ensure reliability of the memory cell, and thus the ensured number of data rewritings is small. While the ensured number of data rewritings of a conventional single-level NAND flash memory is, for example, 100,000 rewritings, that of the multi-level NAND flash memory is, for example, 10,000 rewritings, resulting in deterioration to approximately one-tenth. Additionally, it already becomes hard to merely manufacture the flash memory ensuring 10,000 rewritings.

The ensured number of rewritings of the flash memory is directly linked to a lifetime of the semiconductor memory card and to a lifetime of an apparatus itself such as the portable audio apparatus. A user using the apparatus such as the nonvolatile memory device and the portable audio apparatus conventionally considered the lifetimes of these apparatuses are semipermanent. However, in a case of using a product mounting the flash memory whose ensured number of rewritings is limited, it is important especially for a user frequently rewriting data to use the product in consideration of the lifetime or to select a product in consideration of a product lifetime.

To handle this problem, a nonvolatile memory system where a user can recognize a lifetime of a memory was conventionally proposed, for example, as shown in Patent document 1 and Patent document 2. According to these documents, the user can recognize an estimated lifetime of the nonvolatile memory by displaying the number of rewritings of the nonvolatile memory that has a lifetime of the rewriting to the user.

Patent document 1: Japanese Unexamined Patent Publication No. H07-141899

Patent document 2: Japanese Unexamined Patent Publication No. 2001-195316

### DISCLOSURE OF THE INVENTION

### Problems to be Solved by the Invention

However, in the above-mentioned conventional technique, a user had to preliminarily recognize the guaranteed number of rewritings of a nonvolatile memory, and it could not be said that an estimated lifetime can be easily recognized.

In a business-use system for recording data such as a professional-use moving image recording apparatus, such problem is quite distinguished. In other words, in the professional-use moving image recording apparatus using a semiconductor memory card as a recording medium, it is important to accurately recognize a lifetime of the memory card and to change the card when the lifetime is over. For example, in a nonvolatile memory device of 4 GB including a flash memory whose guaranteed number of rewritings is 100,000, when image shooting is done at a recording rate of 25M bytes/sec for 2 hours every day, approximately 44 rewritings is carried out to the whole region of 4 GB a day based on expression (1),

(2×3600 sec/day)/(4 GB/25 MB/sec)=approx. 44 times/day (1).

Accordingly, the lifetime of the semiconductor memory card is estimated to be approximately 227 days based on expression (2),

10,000 times/44 times/day=approx. 227 days (2).

However, it is very troublesome to certainly manage operating time a day and the number of use-days.

The present invention solves the above-mentioned problems of the apparatus incorporating the nonvolatile memory such as the nonvolatile memory device or the portable audio apparatus. The present invention intends to provide a memory controller, a nonvolatile memory device, and a nonvolatile memory system which: allow a user easily recognizing time when these apparatuses become out of usable condition; and can be automatically, immediately before the lifetime is over, switched to a mode (hereinafter referred to as a write once mode) to allow the writing only once.

### Means to Solve the Problems

To solve the problems, a memory controller which writes data to a nonvolatile memory and reads data from said nonvolatile memory in accordance with an access order from an outside, comprises: a read-write control part for carrying out read-write control of data to said nonvolatile memory, the read-write control part being provided with a plurality of read-write control modes including: a rewritable mode for reading and writing data from and to an arbitrary address of said nonvolatile memory; and a write once mode for carrying out last writing of data to each physical address, a lifetime parameter generation part for generating a lifetime parameter related to at least one of an occurrence capacity of memory defect of said nonvolatile memory and a number of memory rewritings of said nonvolatile memory; and a mode switching part for switching said read-write control mode from the rewritable mode to the write once mode and outputting control mode information to specify the read-write control mode when the lifetime parameter generated by said lifetime parameter generation part exceeds a predetermined threshold value.

Said lifetime parameter may be at least one of: a ratio of an occurrence capacity of memory defect of said nonvolatile memory to an allowable capacity of memory defect of said nonvolatile memory; an estimated time when the occurrence capacity of memory defect reaches the allowable capacity of memory defect; a ratio of the occurrence capacity of memory defect to a total capacity of said nonvolatile memory; a parameter related to a remaining capacity allowing memory defect; and a ratio of the number of rewritings of the nonvolatile memory to a guaranteed number of rewritings of said nonvolatile memory.

Said nonvolatile memory may be configured by including a plurality of physical blocks, and an allowable capacity and an occurrence capacity of memory defect of said nonvolatile memory may be in units of a number of physical blocks of said nonvolatile memory.

Said mode switching part may switch the control mode to a read only mode for enabling only data reading when data have been written to all addresses of said nonvolatile memory in the write once mode.

To solve the problems, a nonvolatile memory device writes and reads data in accordance with an access order from an outside, wherein said nonvolatile memory device comprises: a nonvolatile memory; and a memory controller for writing data to said nonvolatile memory and reading data from said nonvolatile memory, and said memory controller includes: a read-write control part for carrying out read-write control of data to said nonvolatile memory, the read-write control part being provided with a plurality of read-write control modes including: a rewritable mode for reading and writing data from and to an arbitrary address of said nonvolatile memory; and a write once mode for carrying out last writing of data to each physical address, a lifetime parameter generation part for generating a lifetime parameter related to at least one of an occurrence capacity of memory defect of said nonvolatile memory and a number of memory rewritings of said nonvolatile memory; and a mode switching part for switching said read-write control mode from the rewritable mode to the write once mode and outputting control mode information to specify the read-write control mode when the lifetime parameter generated by said lifetime parameter generation part exceeds a predetermined threshold value.

Said lifetime parameter may be at least one of: a ratio of an occurrence capacity of memory defect of said nonvolatile memory to an allowable capacity of memory defect of said nonvolatile memory; an estimated time when the occurrence capacity of memory defect reaches the allowable capacity of memory defect; a ratio of the occurrence capacity of memory defect to a total capacity of said nonvolatile memory; a parameter related to a remaining capacity allowing memory defect; and a ratio of the number of rewritings of the nonvolatile memory to a guaranteed number of rewritings of said nonvolatile memory.

Said nonvolatile memory may be configured by including a plurality of physical blocks, and an allowable capacity and an occurrence capacity of memory defect of said nonvolatile memory may be in units of a number of physical blocks of said nonvolatile memory.

Said mode switching part may switch the control mode to a read only mode for enabling only data reading when data have been written to all addresses of said nonvolatile memory in the write once mode.

To solve the problems, a nonvolatile memory system has: an access device; and a nonvolatile memory device which writes and reads data in accordance with an access order from said access device, wherein said nonvolatile memory device comprises: a nonvolatile memory; and a memory controller for writing data to said nonvolatile memory and reading data from said nonvolatile memory, and said memory controller includes: a read-write control part for carrying out read-write control of data to said nonvolatile memory, the read-write control part being provided with a plurality of read-write control modes including: a rewritable mode for reading and writing data from and to an arbitrary address of said nonvolatile memory; and a write once mode for carrying out last writing of data to each physical address, a lifetime parameter generation part for generating a lifetime parameter related to at least one of an occurrence capacity of memory defect of said nonvolatile memory and a number of memory rewritings of said nonvolatile memory; and a mode switching part for switching said read-write control mode from the rewritable mode to the write once mode and outputting control mode information to specify the read-write control mode when the lifetime parameter generated by said lifetime parameter generation part exceeds a predetermined threshold value.

Said lifetime parameter may be at least one of: a ratio of an occurrence capacity of memory defect of said nonvolatile memory to an allowable capacity of memory defect of said nonvolatile memory; an estimated time when the occurrence capacity of memory defect reaches the allowable capacity of memory defect; a ratio of the occurrence capacity of memory defect to a total capacity of said nonvolatile memory; a parameter related to a remaining capacity allowing memory defect; and a ratio of the number of rewritings of the nonvolatile memory to a guaranteed number of rewritings of said nonvolatile memory.

Said nonvolatile memory may be configured by including a plurality of physical blocks, and an allowable capacity and an occurrence capacity of memory defect of said nonvolatile memory may be in units of a number of physical blocks of said nonvolatile memory.

Said mode switching part may switch the control mode to a read only mode for enabling only data reading when data have been written to all addresses of said nonvolatile memory in the write once mode.

To solve the problems, an access device used by being connected to a nonvolatile memory device having a nonvolatile memory, comprises: a control part for formatting said nonvolatile memory device after, based on read-write control mode information outputted from said nonvolatile memory device, a read-write control mode specified by said read-write control mode is switched to a write once mode.

Said access device may have a display circuit for displaying said read-write control mode information.

The access device may include a receiving part for receiving the read-write control mode information and the lifetime parameter outputted from said nonvolatile memory device.

### Effectiveness of the Invention

According to the present invention, a lifetime parameter related to a lifetime of a nonvolatile memory device is generated on the basis of: a generated capacity of memory defect of a nonvolatile memory; or the number of memory rewritings, and the mode switching part switches a read-write mode of the nonvolatile memory device from a rewritable mode to a write once mode and notifies an access device of the switching to the write once mode. In this manner, since being able to recognize the switching to the write once mode, the user can use the device in line with the switching, for example, to record data to be permanently stored to the nonvolatile memory device.

### BRIEF DESCRIPTION OF DRAWINGS

FIG. 1A is a block diagram showing a nonvolatile memory device of a nonvolatile memory system according to an embodiment of the present invention.

FIG. 1B is a block diagram showing an access device of the nonvolatile memory system according to the embodiment of the present invention.

FIG. 2 is a memory map showing a memory type table included in a parameter 1 determination part 125.

FIG. 3 is a memory map showing a correspondence relationship between a logical address space and a physical address space.

FIG. 4 is an explanation view showing a physical block constituting a memory cell array 142.

FIG. 5 is an explanation view showing a configuration of the physical block.

FIG. 6 is a memory map showing a physical region management table included in a read-write control part 124.

FIG. 7 is a memory map showing a logical-physical conversion table included in the read-write control part 124.

FIG. 8 is an explanation view showing a configuration of a lifetime parameter retention block.

FIG. 9 is a graph showing a temporal transition of parameter P2.

FIG. 10 is a flowchart showing a process in a normal operation.

FIG. 11A is a flowchart showing an outlined process of data writing.

FIG. 11B is a flowchart showing the outlined process of data writing.

FIG. 12A is an explanation view showing a case where no error exists in data writing.

FIG. 12B is an explanation view showing a case where an error exists in data writing.

FIG. 12C is an explanation view showing a case where an error exists in data writing.

FIG. 13 is a flowchart showing a detailed process of data writing.

### EXPLANATION FOR REFERENCE NUMERALS

100 Access device

101 Receiving part

102 Control circuit

103 Display circuit

104 Timer circuit

110 Nonvolatile memory device

120 Memory controller

121 Host interface

122 Buffer

123 Memory interface

124 Read-write control part

125 Parameter 1 determination part

126 Parameter 2 calculation part

127 Lifetime parameter processing part

128 Lifetime parameter generation part

129 Mode switching part

130 CPU part

140 Nonvolatile memory

141 Register

142 Memory cell array

143 Control circuit

144 ID code

145 Normal region

146 Register region

147 System region

148 Spare region

149 Lifetime parameter retention block

### BEST MODE FOR CARRYING OUT THE INVENTION

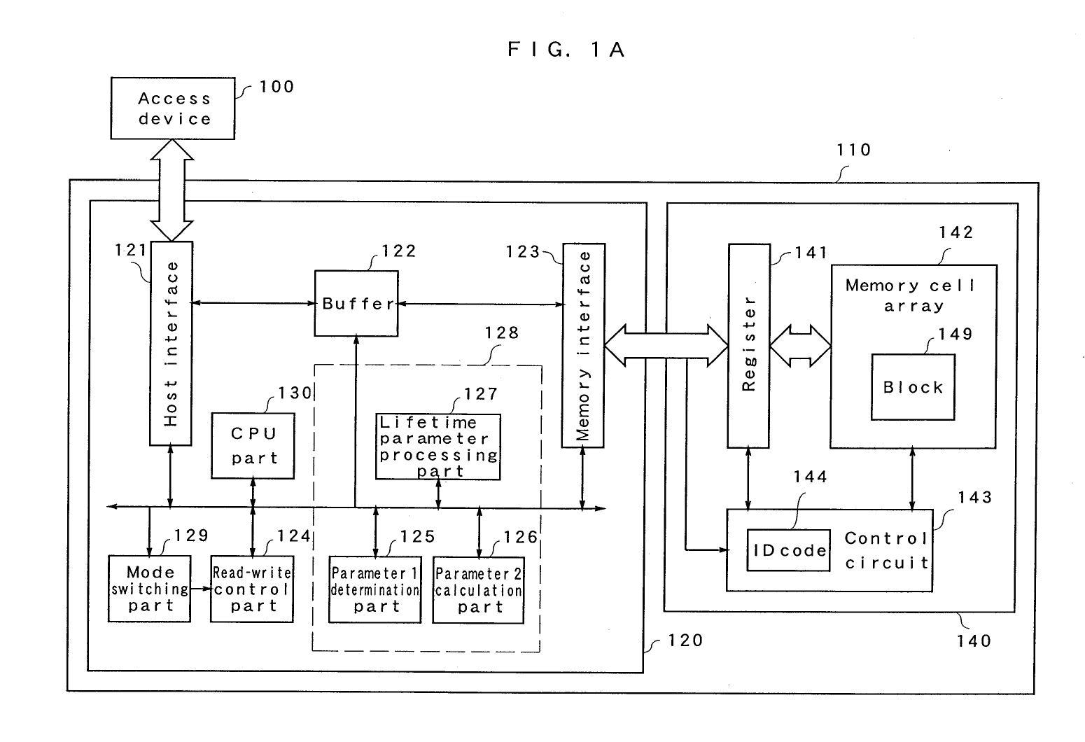

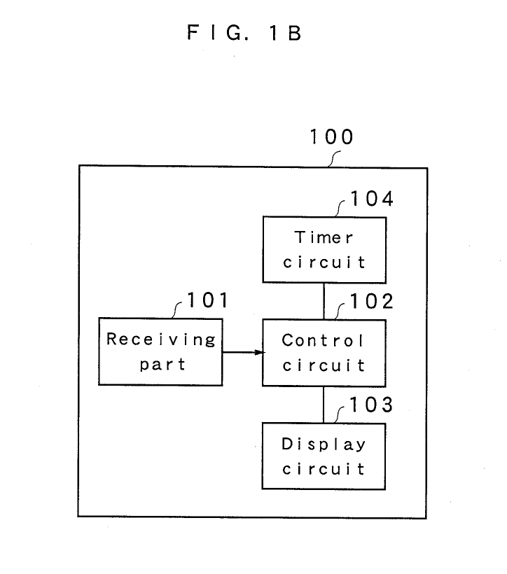

FIG. 1A is a block diagram showing a nonvolatile memory device of a nonvolatile memory system according to an embodiment of the present invention, and FIG. 1B is a block diagram showing an access device thereof. In FIG. 1A and FIG. 1B, the nonvolatile memory system is configured by including an access device 100 and a nonvolatile memory device 110. The access device 100 and the nonvolatile memory device 110 are connected via a bus 1. The nonvolatile memory device 110 includes a memory controller 120 and a nonvolatile memory 140. The memory controller 120 and the nonvolatile memory 140 are connected via a bus 2.

The memory controller 120 includes a host interface 121, a buffer 122, a memory interface 123, a read-write control part 124, a parameter 1 determination part 125, a parameter 2 calculation part 126, a lifetime parameter processing part 127, a mode switching part 129, and a CPU part 130. The parameter 1 determination part 125, the parameter 2 calculation part 126, and the lifetime parameter processing part 127 are collectively referred to as a lifetime parameter generation part 128.

The host interface 121 is a block for receiving a command related to data writing and reading, a logical address, and data from the access device 100 and for sending data to the access device 100 in the data reading.

The buffer 122 is used for absorbing difference between a data transfer rate of the bus 1 and a data transfer rate of the bus 2. Its size is a capacity twice as much as a size of a register 141 in the nonvolatile memory 140 described later, 4 k bytes here.

The memory interface 123 is a block for writing data temporarily stored in the buffer 122 to the nonvolatile memory 140 and for reading data stored in the nonvolatile memory 140 into the buffer 122.

The CPU part 130 is a block for controlling the whole memory controller 120.

The read-write control part 124 reads and writes data from and to the nonvolatile memory 140 on the basis of a command from the access device 100. The read-write control part 124 has a volatile RAM for storing a physical region management table and a logical-physical conversion table. The physical region management table shows a use state of each physical block in the nonvolatile memory 140 and the logical-physical conversion table converts a logical address into a physical address, and details of these tables will be described later. The read-write control part 124 has three read-write control modes, a rewritable mode, a write once mode, and a read only mode. The rewritable mode is for: allocating a physical address of the nonvolatile memory 140 to an arbitrary logical address received from the access device 100 on the basis of a writing or reading command and the like; writing, reading and erasing data; and erasing data written in an former physical address in updating data. This mode corresponds to a writing method in an optical disk, for example, the CD-RW and the CD-RAM. The write once mode is for: carrying out last writing of data to each physical address; not erasing data; and reading data from an arbitrary address. This mode corresponds to a writing method in an optical disk, for example, the CD-R. The read only mode is for only reading data on the basis of a reading command. In addition, the read-write control part 124 has a function for outputting a lifetime parameter retained by a lifetime parameter retention part described later to outside in accordance with a command from the access device 100.

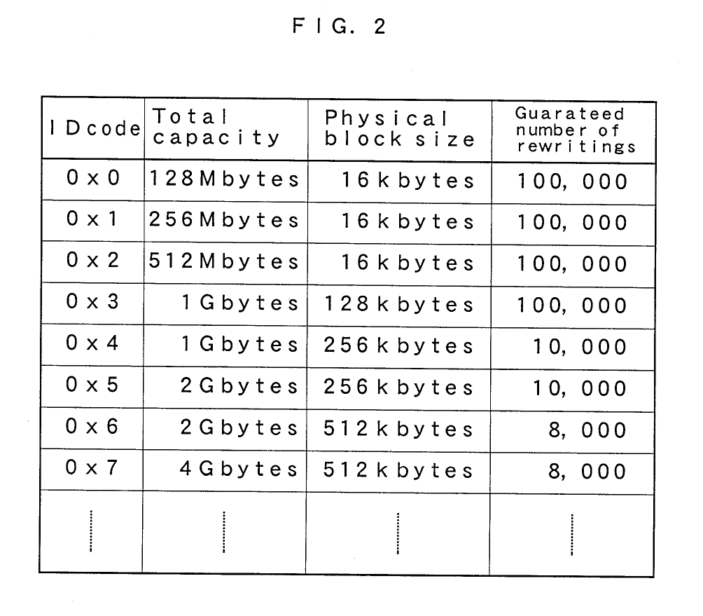

The parameter 1 determination part 125 is a block for: referring to an ID code 144 of the nonvolatile memory 140; and determining parameter P1 on the basis of a capacity of the nonvolatile memory 140, the parameter P1 of the allowable number of bad blocks. As shown in FIG. 2, the parameter 1 determination part 125 includes a type information table of the nonvolatile memory in a memory such as a ROM. The type information table shows a total capacity, a physical block size, and the guaranteed number of rewritings related to an ID code showing a type of the nonvolatile memory. The guaranteed number of rewritings is determined on the basis of a shipping examination by a manufacturer of the nonvolatile memory, and a value of the guaranteed number of rewritings of the nonvolatile memory is not constant. The parameter 1 determination part 125 retains the allowable number of bad blocks calculated on the basis of this table as parameter P1.

The parameter 2 calculation part 126 is a block for counting the number of physical blocks that caused an error in data writing to the present nonvolatile memory 140 as parameter P2.

The lifetime parameter processing part 127 is a block for: incorporating a timer circuit; and processing parameters P1 and P2 into first to fifth lifetime parameters as described later. This timer circuit constantly counts time during an electric power is supplied to the nonvolatile memory device.

The mode switching part 129 has a volatile internal register for retaining the present read-write control mode, and switches the read-write control mode in accordance with the lifetime parameter. The mode switching part 129 retains a threshold value used for the switching in a ROM. The mode switching part 129 firstly sets the read-write control mode to be the rewritable mode, then switches the mode to the write once mode, and finally switches the mode to the read only mode when all writable spaces have been consumed in the write once mode. In addition, the mode switching part 129 has a function for outputting the present mode to the access device 100.

Meanwhile, the nonvolatile memory 140 has a resister 141, a memory cell array 142, and a control circuit 143. The resister 141 is a volatile RAM having a size same as that of a page that is a writing unit described later, and temporarily retains data transferred from the memory interface 123. The memory cell array 142 is a flash memory having a capacity, for example, of 1 G bytes, and is composed of a plurality of physical blocks.

The control circuit 143 retains the ID code 144 for identifying the nonvolatile memory 140, and controls the resister 141 and the memory cell array on the basis of a writing command and a physical address transferred from the memory interface 123. The ID code 144 is a code enabling identification of a type of the nonvolatile memory 140, and is preliminarily stored in a ROM and the like of the control circuit 143 at the time of manufacturing the flash memory. The ID code 144 may be preliminarily written to a part of region in the memory cell array 142.

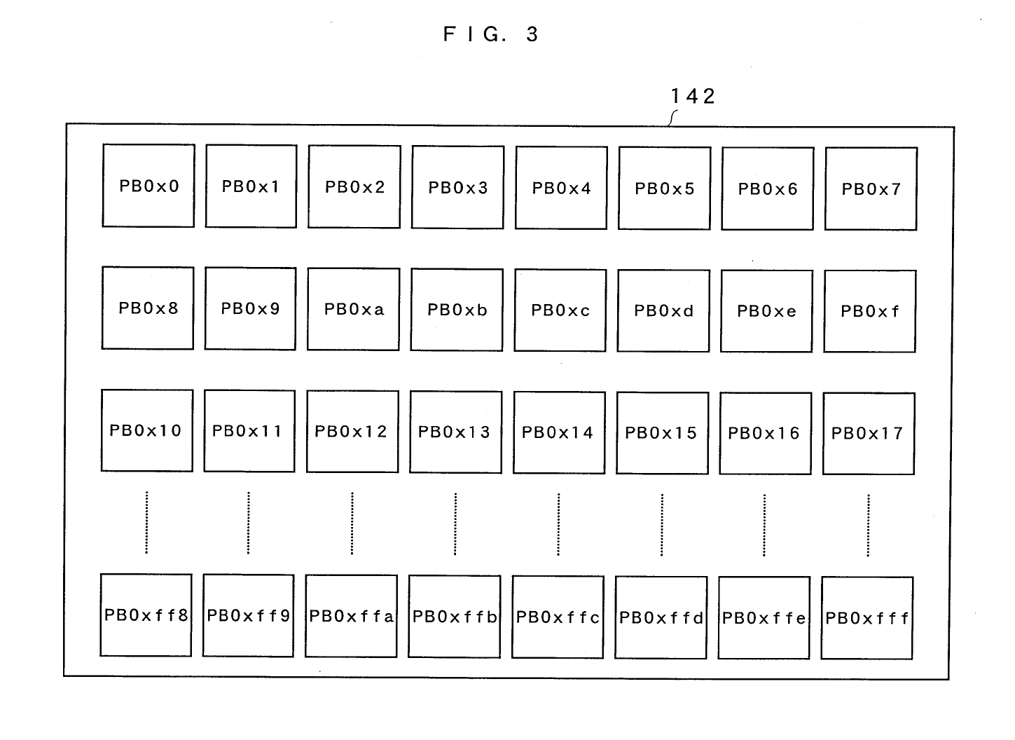

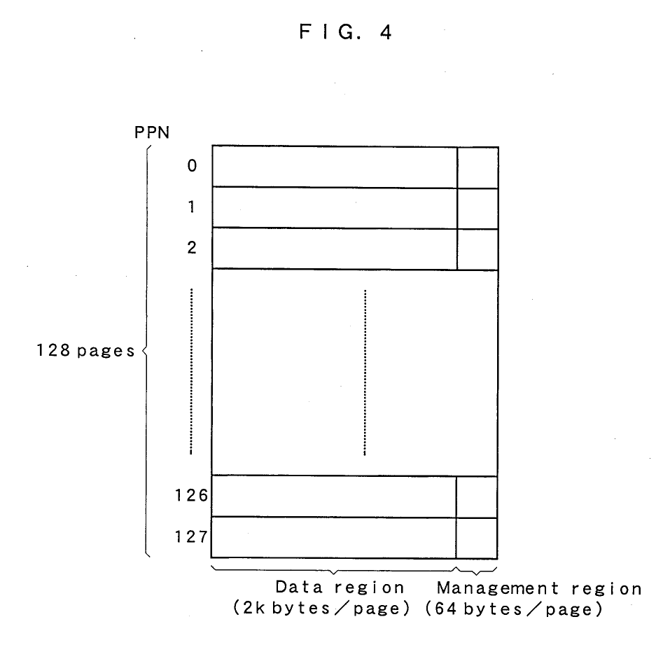

FIG. 3 is a view showing a configuration of the memory cell array 142. As shown in FIG. 3, the memory cell array 142 has a capacity, for example, of 1 GB, and is composed of 4096 physical blocks from PB0x0 to PB0xfff (0x is an indicator of hexadecimal number). As shown in FIG. 4, each of the physical blocks is composed of 128 pages from physical page numbers PPN0 to PPN127. A data region in that has 2 k bytes per page. One page further includes a management region of 64 bytes. The data region of each page generally stores data sent from the access device 100. The management region stores an ECC code for error correction and the like. The physical block is an erasing unit, and the page is a writing unit. The data region size of each physical block is 256 k bytes. A size of the resister 141 is 2 k bytes same as the capacity of the page.

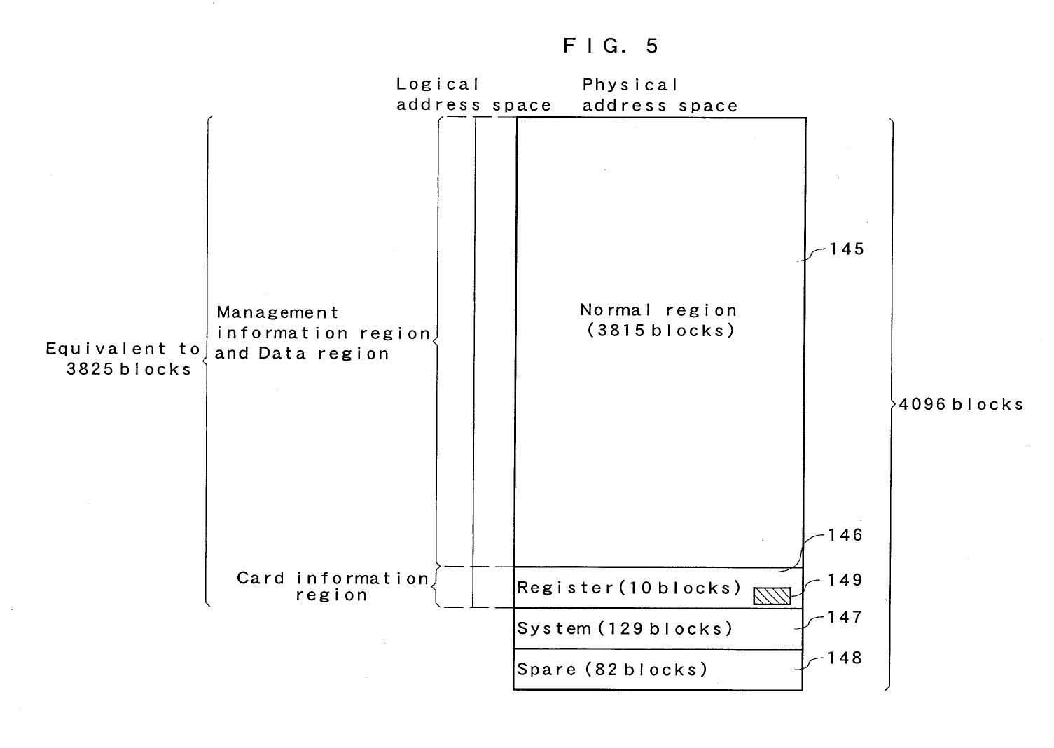

FIG. 5 is a view illustrating a memory map showing a correspondence relationship between a logical address space and a physical address space of the nonvolatile memory 140. As described above, the physical address space is composed of 4096 blocks, the space including a normal region 145 of 3815 blocks, a register region 146 of 10 blocks, a system region 147 of 129 blocks, and a spare region 148 of 82 blocks. These regions are formed by an initialization process described later. A lifetime parameter retention block 149 is provided in the register region 146. The lifetime parameter retention block 149 is the lifetime parameter retention part for retaining the lifetime parameter described later.

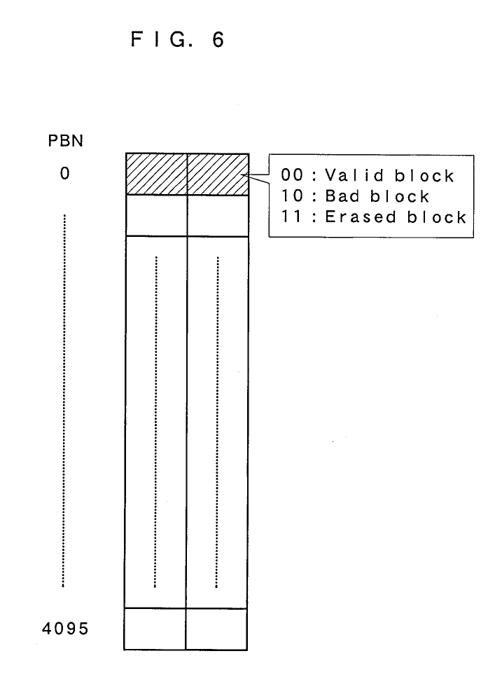

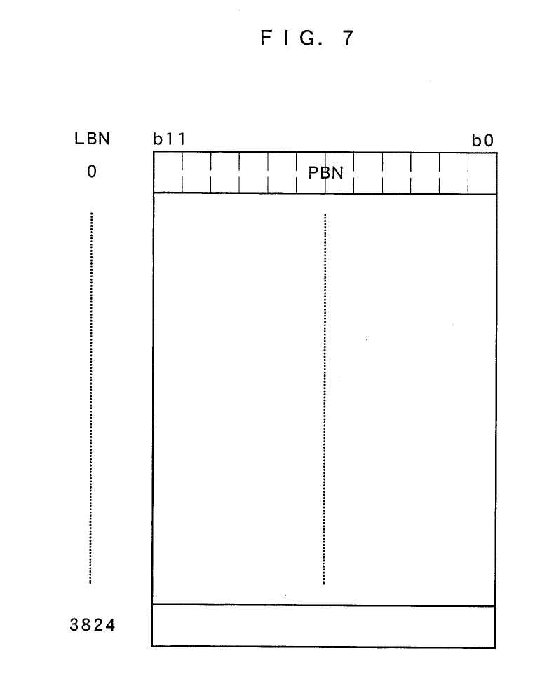

The physical region management table (1 k byte) shown in FIG. 6 and the logical-physical conversion table (6 k bytes) shown in FIG. 7 are stored in a physical block in the system region 147. The physical region management table represents a block status of each physical block, namely, a valid block, a bad block, and an erased block by 2 bits of 00, 10, 11, respectively. In addition, the logical-physical conversion table is a table for converting a logical block number LBN into a physical block number PBN. These tables are copied to a RAM of the read-write control part 124 at the time of starting the power supply.

The access device 100 writes and reads data to and from the nonvolatile memory device 110, and internally includes a receiving part 101, a control circuit 102, a display circuit 103, and a timer circuit 104 as shown in FIG. 1B. The receiving part 101 is a block for receiving the read-write control mode and the lifetime parameter retained by the lifetime parameter retention block 149. The control circuit 102 is a circuit that: is connected to the timer circuit 104; and transfers a displaying command to the display circuit 103 and a receiving command to the receiving part 101. The displaying circuit 103 is a circuit for displaying the read-write control mode and information related to lifetime on the nonvolatile memory device 110.

Dividing a description in an initial state, an initialization process at the time of starting the power supply, a mode switching process, and a data writing process in normal operation, the nonvolatile memory system according to the embodiment will be explained.

[Initial State]

At first, details of the initialization process executed by a manufacturer side before the shipping of the nonvolatile memory device 110 will be explained. FIG. 5 shows a correspondence relationship between the logical address space managed by the access device 100 and the physical address space of the nonvolatile memory device 110, and the logical address space in smaller than the physical address space. Before the shipping of the nonvolatile memory device 110, a bad block is preliminarily searched by a rewriting examination for entire region of the nonvolatile memory 140. The bad block found at this time is referred to as an “initial bad block”, a physical block number of the bad block is retained so that a block status of a corresponding physical block number in the physical region management table can be set to be a bad block.

Next, in the initialization process, system information such as secure information is stored in the system region 147 of FIG. 5 after erasing the entire region. The physical region management table shown in FIG. 6 and the logical-physical conversion table shown in FIG. 7 are stored in a physical block that is not a bad block in the system region 147. Additionally, in the physical region management table, a block status of bad bock is set to a value “10” and a block status of a physical block that is not a bad block is set to a value “11”. Oxfff is set in each row of the logical-physical conversion table. In addition, attribution information as the nonvolatile memory device (semiconductor memory card), for example, a card capacity is stored in the register region 146.

While sizes of the register region 146 and the system region 147 vary with different types of the nonvolatile memory device, the register region 146 in the embodiment is composed of 10 blocks (2560 k bytes) and the system region 147 is composed of 129 blocks (33024 k bytes).

The normal region 145 stores: so-called file data such as image data and music data sent from the access device 100; and management information (for example, FAT information) for managing the file data. The file data and the management information are collectively and simply referred to as data. The spare region 148 is ensured as a substitution region for a bad block that occurred in the writing to each region. It is preferable that the spare region 148 ensures a capacity of 2% or more of a size of the entire region. That is based on policy of the guaranteed number of rewritings issued by the manufacture of flash memory. For example, guaranteeing 10,000 rewritings means that a total size of bad blocks occurred by the 10,000 rewritings is 2% or lass of the entire region. In the embodiment, 82 blocks are retained as the spare region 148 by a roundup process based on expression (3),

(1 G bytes/256 k bytes)×2%≈82 blocks (3).

However, depending on a type of the nonvolatile memory device, the register region 146 and the system region 147 have a relatively large size and the spare region 148 is sometimes smaller than a size of 82 blocks.

When the rewriting is repeated, the spare region 148 is completely consumed and the nonvolatile memory device cannot record data. To manage this timing, the last physical block of the register region 146 is provided as the lifetime parameter retention block 149. When seen from the access device 100, the lifetime parameter retention block 149 is arranged to the last logical block number in the logical address space, namely, LBN=3824. Accordingly, in the initial process, 3824 (0xefd in the hexadecimal number) is preliminarily stored as a physical block number PBN at a position where the logical block number LBN in the logical-physical conversion table shown in FIG. 7 is 3824.

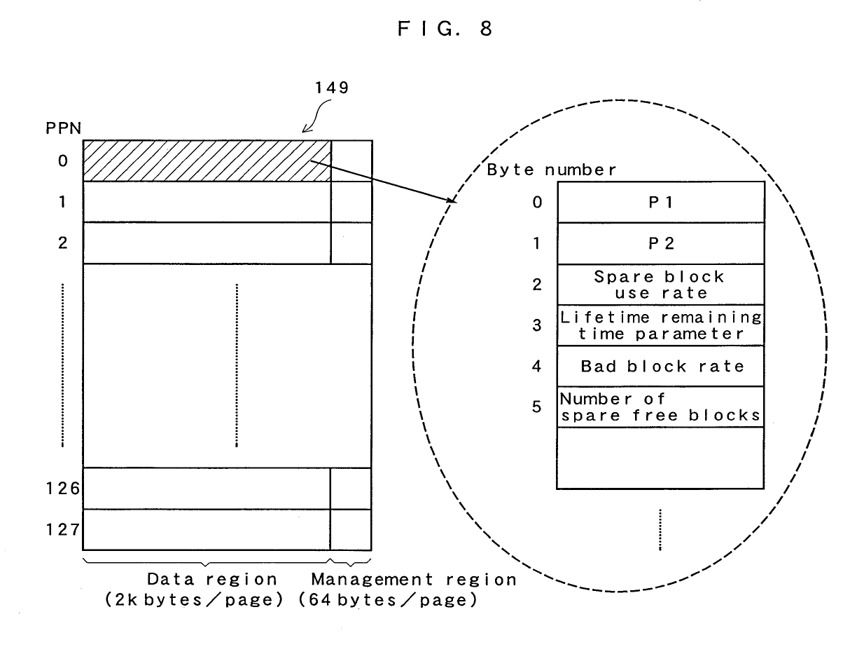

FIG. 8 is a view showing the lifetime parameter retention block 149. This physical block stores a lifetime parameter in physical page number 0x0. Parameter P1, parameter P2, a spare block use rate, a lifetime remaining time parameter, a bad block rate, and the number of spare free blocks are arranged in ascending order from a lower byte of the physical page number 0x0, that is, from byte number 0. These parameters are collectively referred to as the lifetime parameter.

Parameter P1 is an allowable capacity of bad block, namely, the number of physical blocks in the spare region, and is 82 blocks in this case. Meanwhile, parameter P2 is the number of occurred bad blocks, namely, the number of bad blocks already occurred at that time. In the embodiment, the number of bad blocks is, for example, 1 in the initial state. As shown in FIG. 8, values of parameter P1 and parameter P2 are stored in byte numbers 0 and 1 in physical page number 0 of the lifetime parameter retention block.

In the initialization process, the read-write control mode of the read-write control part 124 is further registered to the register region 146.

[Initialization Process at the Time of Starting the Power Supply]

Next, an initialization process at the time of turning on the power supply when a user uses the device will be explained. When the power supply of the access device 100 is tuned on, the power supply of the nonvolatile memory device 110 is also turned on via the bus 1 and the nonvolatile memory device 110 shifts to the initialization process. In the initialization process, the CPU part 130 temporarily retains the physical region management table and the logical-physical conversion table stored in the system region 147 in an internal volatile RAM of the read-write control part 124 via the memory interface 123. After that, in the data reading and writing, a physical address is determined by using these tables temporarily stored in the internal RAM of the reading-writing control part 124. In addition, when each table is updated, the table is written back to the nonvolatile memory 140 in each updating in case of power-off.

Next, the parameter 1 determination part 125 reads the ID code 144 via the memory interface 123, and refers to the memory type table shown in FIG. 2. For example, in a case where the ID code is 0x4, the nonvolatile memory 140 is a memory where: a capacity is 1 GB; a physical block size is 256 k bytes; and the guaranteed number of rewritings is 10,000. The parameter 1 determination part 125 calculates the number of blocks in the spare region, namely, 82 blocks as parameter P1 by executing expression (3), and stores the parameter in the parameter 1 determination part 125.

Next, the mode switching part 129 reads the read-write control mode information of the register region 146 into the internal register and notifies the access device 100 of the information. The control circuit 102 in the access device 100 receives the read-write control mode information via the receiving part 110, and displays the mode, namely, the rewritable mode, the write once mode, or the read only mode on the display circuit 103. The access device 100 may recognize the present read-write control mode by directly reading the register region 146.

Next, the CPU part 130 completely clears the buffer 122, and notifies the access device 100 of the completion of initialization via the host interface 121.

The parameter 2 calculation part 126 refers to the physical region management table, counts the number of blocks whose block status shows a value 10, namely, bad blocks, and retains the counted value as a parameter P2 in the parameter 2 calculation part 126. When the number of bad blocks is 1 immediately after the shipping as described above, parameter P2 shows a value 1.

The lifetime parameter processing part 127 generates below-mentioned five types of parameters as the lifetime parameter. The embodiment may execute all of the five types of parameters or a part of them. In addition, the lifetime parameter is executed not only at the time of starting the power supply but also at the time when an error occurred in a physical block.

(1) Parameters P1 and P2

A first parameter is: parameter P1 that is the allowable capacity of memory defect of the nonvolatile memory 140, namely, the number of physical blocks of the spare region 148; and parameter P2 that is an occurrence capacity of the memory defect of the nonvolatile memory 140, namely, the number of physical blocks actually turned into a bad block. The lifetime parameter processing part 127 reads parameter P1 that the parameter 1 determination part 125 internally retains, and records the parameter to byte number 0 of physical page number 0 of the lifetime parameter retention block 149. As described above, when parameter P1 is stored in the lifetime parameter retention block 149 in the process before the shipping, the writing is not required here. Subsequently, the lifetime parameter processing part 127 reads parameter P2 that the parameter 2 calculation part 126 internally retains, and records the parameter to byte number 1 of physical page number 0 of the lifetime parameter retention block 149. Specifically, in the generation process of the first parameter, the lifetime parameter processing part 127 carries out a process for: simply reading parameter P1 and parameter P2 from the parameter 1 determination part 125 and the parameter 2calculation part 126, respectively; and only writing the parameters to the block 149.

(2) Spare Block Use Rate

A second parameter represents a use rate of the number of physical blocks used instead of present bad blocks to the number of physical blocks of the spare region allowing memory defect. The lifetime parameter processing part 127 obtains a spare block use rate from expression (4), and records the use rate to byte number 2 of physical page number 0 of the block 149,

Spare block use rate=P2/P1 (4).

The spare block use rate is a parameter related to a ratio of the occurrence capacity of memory defect to the allowable capacity of memory defect of the nonvolatile memory.

(3) Lifetime Remaining Time Parameter

A third parameter represents estimated remaining time of a lifetime of the nonvolatile memory device 110. The lifetime parameter processing part 127 obtains a lifetime remaining time parameter from following expression (5). Time Tₙ is a cumulative current-carrying time from the shipping to time when the number of bad blocks has reached to n. The timer circuit incorporated in the lifetime parameter processing part 127 counts Tₙ. Value vₙ is a speed to reach time when the number of bad blocks has reached to n, namely, the number of occurred bad blocks per unit time (the number/sec.), and Vₘ is an average speed of bad block occurrence.

Lifetime remaining time parameter=(P1−P2)/Vₘ (5)

Vₘ=(v₁+v₂+vₙ)/n

vₙ=n/Tₙ

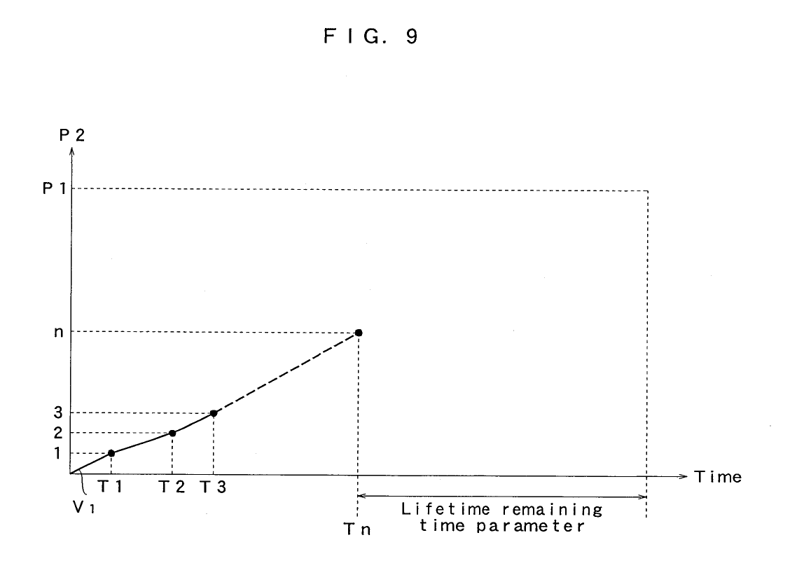

FIG. 9 shows increase of parameter P2 over time and a speed calculated on the basis of the increase. When the present occurrence number of bad blocks is n, time to reach the number of bad blocks of parameter P1 at the average speed is the remaining lifetime.

When an error has occurred in data writing to the nonvolatile memory 140 and a bad block is registered to the physical region management table, the lifetime parameter processing part 127 executes expression (5) and calculates the average speed of bad block occurrence. Values v₁ to vₙ, Vₘ, and Tₙ are sequentially retained in a partial region in the system region of the nonvolatile memory. The lifetime remaining time parameter obtained in this manner is recorded to byte number 3 of physical page number 0 of the block 149.

(4) Bad Block Rate

A fourth parameter is a parameter representing a rate of a bad block. The lifetime parameter processing part 127 obtains the bad block rate by executing following expression (6),

Bad block rate=P2/the number of all physical blocks (6).

This bad block rate is retained at byte number 5 of physical page number 0 of the block 149. The bad block rate is a parameter related to a ratio of the occurrence capacity of memory defect to an entire capacity of the nonvolatile memory. When the bad block rate reaches 0.02, the lifetime of the nonvolatile memory device is over.

(5) Number of Spare Free Blocks

The number of spare free blocks is defined as a fifth parameter. In memory defect, when there is a bad block if the nonvolatile memory 140, a block of the spare region 148 is used as a substitution block. Accordingly, the reduction of number of free blocks in the spare region 148 means that: a remaining capacity reduces; a lifetime becomes short; and the device deteriorates. Accordingly, the number of free blocks corresponding to a remaining capacity of the spare region 148 for memory defect can serve as one of the lifetime parameters. The number of free blocks of the spare region 148 may be directly counted. Instead of this, using the number P1 of spare blocks and parameter P2 using blocks of the spare region, the number can be calculated by following expression (7),

The number of spare free blocks=P1−P2 (7).

When the number of spare free blocks becomes 0, a lifetime of the nonvolatile memory device is over.

### [Process in Normal Operation]

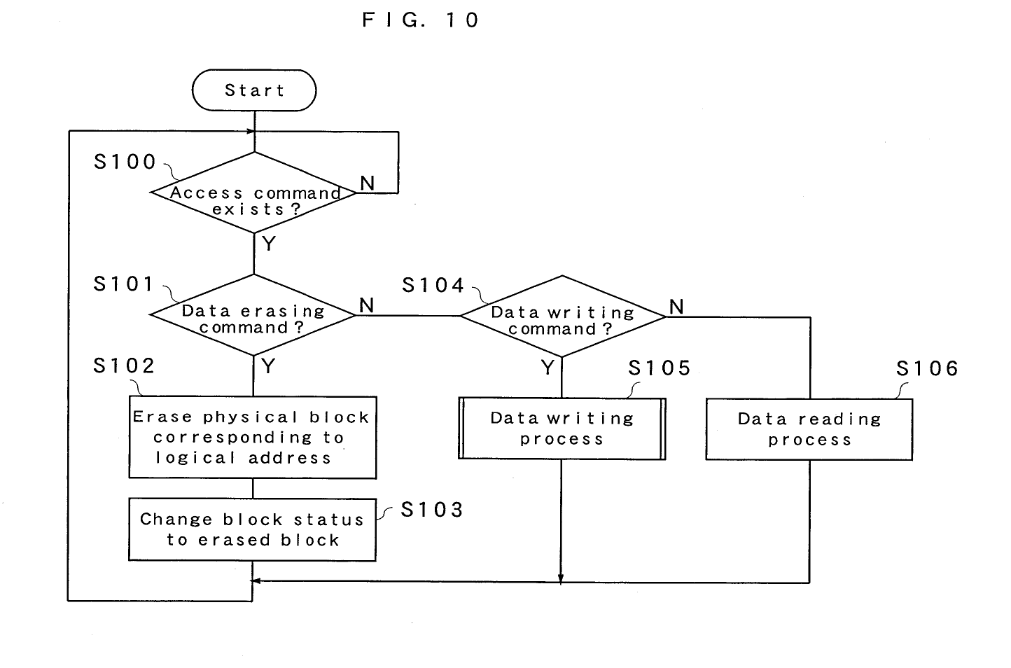

Next, using FIG. 10, a process in a normal operation will be explained. In FIG. 10, when receiving an access order, namely, data writing, reading, or erasing command from the access device 100 (S100), the CPU part 130 shifts control to the read-write control part 124, and determines a type of the access order (S101 and S104). In a case of a data erasing command (S101), data of a physical block corresponding to a designated logical address is erased (S102) and a block status of the physical block in the physical region management table is changed to an erased block (S103). In a case of a data writing command (S104), a data writing process described later is carried out (S105). In a case of not the data writing command, namely, in a case of a data reading command, data is read from a physical block corresponding to a designated logical address (S106).

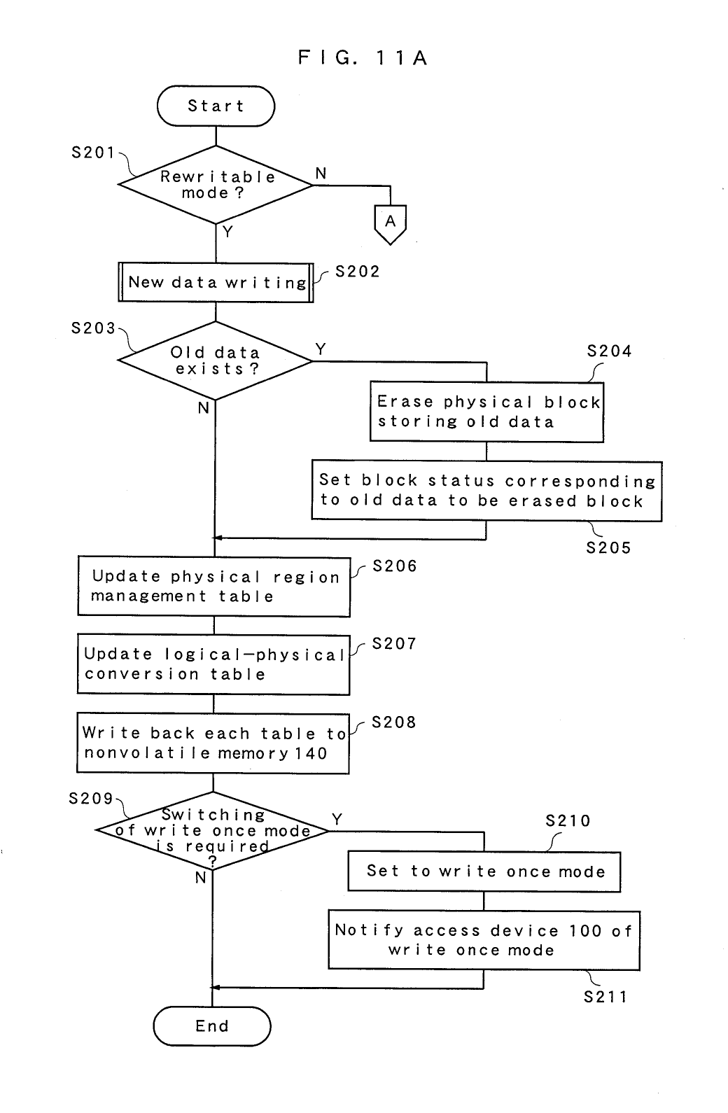

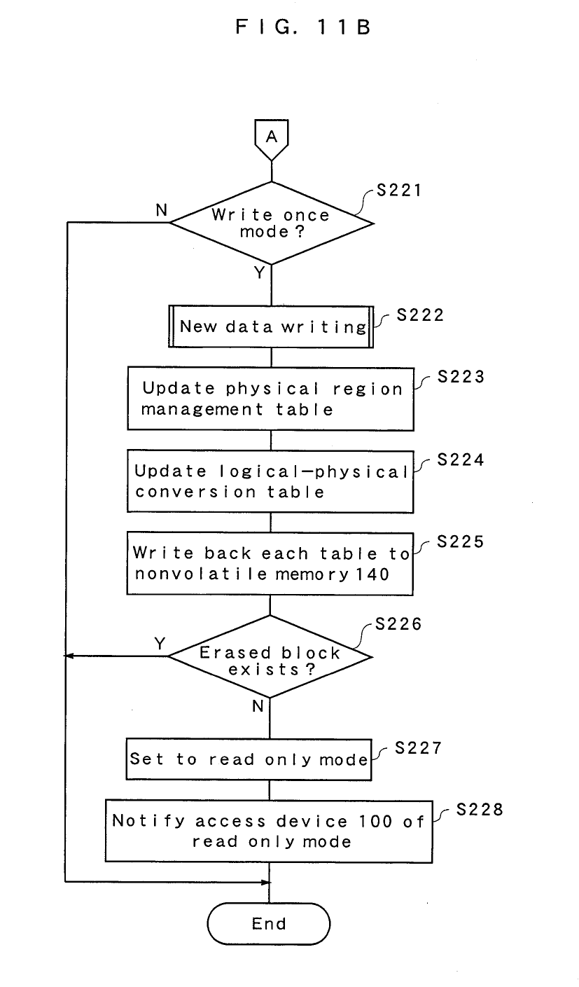

Next, using FIG. 11A and FIG. 11B, an outlined process of data writing will be explained. The read-write control part 124 determines the read-write control mode by referring to the internal register of the mode switching part 129 (S201). In a case where the read-write control mode is the rewritable mode, the process proceeds to S202, and in a case of not the rewritable mode, the process proceeds to S221 in FIG. 11B. In the case of the rewritable mode, the read-write control part 124 writes new data to the nonvolatile memory 140 as described later (S202). Then, referring to a physical block number PBN recorded at a storage position of the logical block number LBN of the new data in the logical-physical conversion table, the read-write control part 124 recognizes the existence of old data when a block status at a storage position of the PBN in the physical region management table is a value 00 (valid block) (S203). The old data stored in a physical block, namely, a physical block corresponding to the PBN is erased (S204). Moreover, the control part changes the block status at the storage position of the PBN to a value 11 (erased block) in the physical region management table (S205). When there is no data, the process proceeds to S206.

Subsequently, a block status at a storage position of a PBN of a block to which data was written is updated to be a value 00 (valid block) in the physical region management table (S206). In addition, the logical-physical conversion table is updated by recording the PBN to which new data was written at a storage position of the LBN of the new data (S207). Then, the updated two tables are written back to the nonvolatile memory 140 (S208). After that, it is judged on the basis of the lifetime parameter whether or not switching to the write once mode is required (S209). When the switching is required, the mode switching part 129 sets the read-write control mode to the write once mode (S210), and notifies the access device 100 that present mode is the write once mode (S211). When the switching is not required at S209, the process ends.

Meanwhile, when it is judged at S201 that the read-write control mode is not the rewritable mode, it is judged at S221 shown in FIG. 11B whether present mode is the write once mode or the read only mode. In case of the write once mode, new data is written in the same manner in the above-mentioned case of the rewritable mode (S222), and the physical region management table and the logical-physical conversion table are updated and written back to the nonvolatile memory 140 (S223 to S225).

Then, it is judged at S226 whether or not an erased block remains. When the erased block remains, the process ends, and when no erased block remains, the mode switching part 129 sets the read-write control mode to the read only mode (S227). And, the mode switching part 129 notifies the access device 100 that present mode is the read only mode at S228, and the process ends. Compared to the rewritable mode, the writing in the write once mode starting from S222 is different in that the erasing process of old data shown at S203 to S205 is not carried out and different in a switching process of the operation mode, namely, details at S226 to S228.

Here, a criterion as to necessity of switching from the rewritable mode to the write once mode at S209 will be explained. The mode switching part 129 has any one of following criterions (A) to (D).

(A) Judgment Based on Spare Block Use Rate

Comparing the spare block use rate to a threshold value A preliminarily set to the ROM in the mode switching part 129, the read-write control part 124 is switched from the rewritable mode to the write once mode when the spare bock use rate is equal to the threshold value A or more. A method for determining a value of the threshold value A will be explained. Since a read-write process is carried out in the write once mode after the mode is switched, the threshold value A is given from expression (8) by referring to expression (4) when the expected number of bad blocks throughout writing of the normal region of the nonvolatile memory 140 is X. A value of X is determined by examining occurrence probability of bad block in a manufacturing process of the nonvolatile memory device 110.

threshold value A=(P1−X)/P1 (8).

By appropriately setting X in this manner, the threshold value A can be determined, for example, to be 0.95.

(B) Judgment Based on Lifetime Remaining Time Parameter

The lifetime remaining time parameter is compared to a threshold value B preliminarily set in the ROM in the mode switching part 129, and when the lifetime remaining parameter is the threshold value B or less, the read-write control part 124 is switched from the rewritable mode to the write once mode. Here, a method for determining a value of the threshold value B will be explained. Since the writing is carried out in the write once mode after the mode switching, the threshold value B is given from expression (9) by referring expression (5) in a case where the expected number of bad blocks throughout writing of the normal region 145 of the nonvolatile memory 140 is X. A value of X is determined by examining occurrence probability of bad block in a manufacturing process of the nonvolatile memory device 110.

Threshold value B=X/Vₘ (9)

Vₘ=(v₁+v₂+vₙ)/n

vₙ=n/Tₙ

(C) Judgment Based on Bad Block Rate

The bad block rate is compared to a threshold value C preliminarily set in the ROM in the mode switching part 129, and when the bad block rate is the threshold value C or more, the read-write control part 124 is switched from the rewritable mode to the write once mode. Here, a method for determining a value of the threshold value C will be explained. Since the writing process is carried out in the write once mode after the mode switching, the threshold value C is given from expression (10) by referring expression (6) in a case where the expected number of bad blocks throughout writing of the normal region 145 of the nonvolatile memory 140 is X. A value of X is determined by examining occurrence probability of bad block in a manufacturing process of the nonvolatile memory device 110.

Threshold value C=(P1−X)/the number of all physical blocks (10).

By appropriately setting X in this manner, the threshold value C can be determined, for example, to be 0.95.

(D) Judgment Based on the Number of Spare Free Blocks

The number of spare free blocks is compared to a threshold value D preliminarily set in the ROM in the mode switching part 129, and when the number of spare free blocks is the threshold value D or less, the read-write control part 124 is switched from the rewritable mode to the write once mode. Here, a method for determining a value of the threshold value D will be explained. Since the writing process is carried out in the write once mode after the mode switching, the threshold value D is given from expression (11) by referring expression (7) in a case where the expected number of bad blocks throughout writing of the normal region 145 of the nonvolatile memory 140 is X. A value of X is determined by examining occurrence probability of bad block in a manufacturing process of the nonvolatile memory device 110.

Threshold value D=X (11).

The mode may be switched by: using any one of above-described judgments of (A) to (D); or using a combination of a plurality of the judgments. In case of the combination of a plurality of the judgments, the switching may be carried out on the basis of their logical OR operation or their logical AND operation.

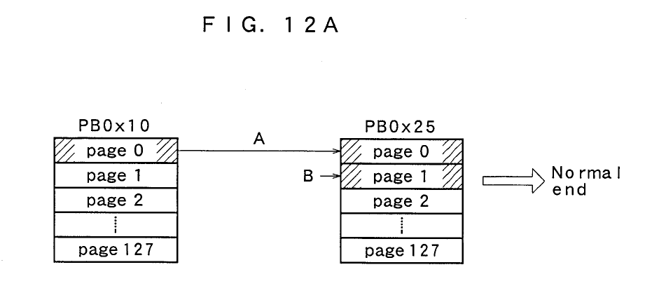

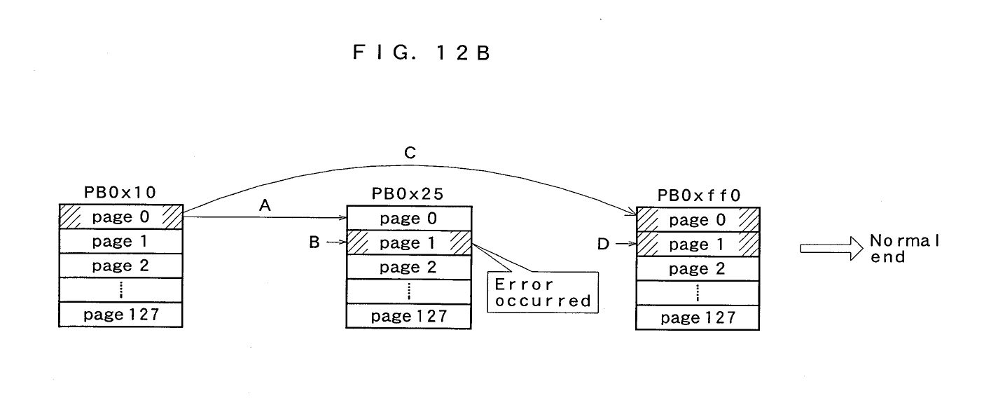

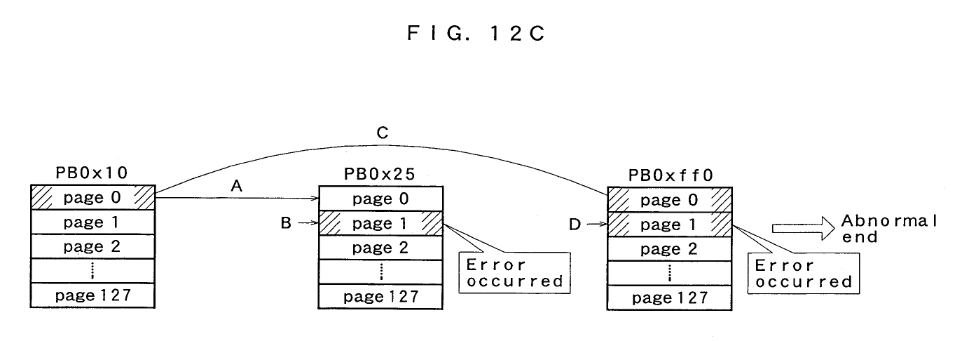

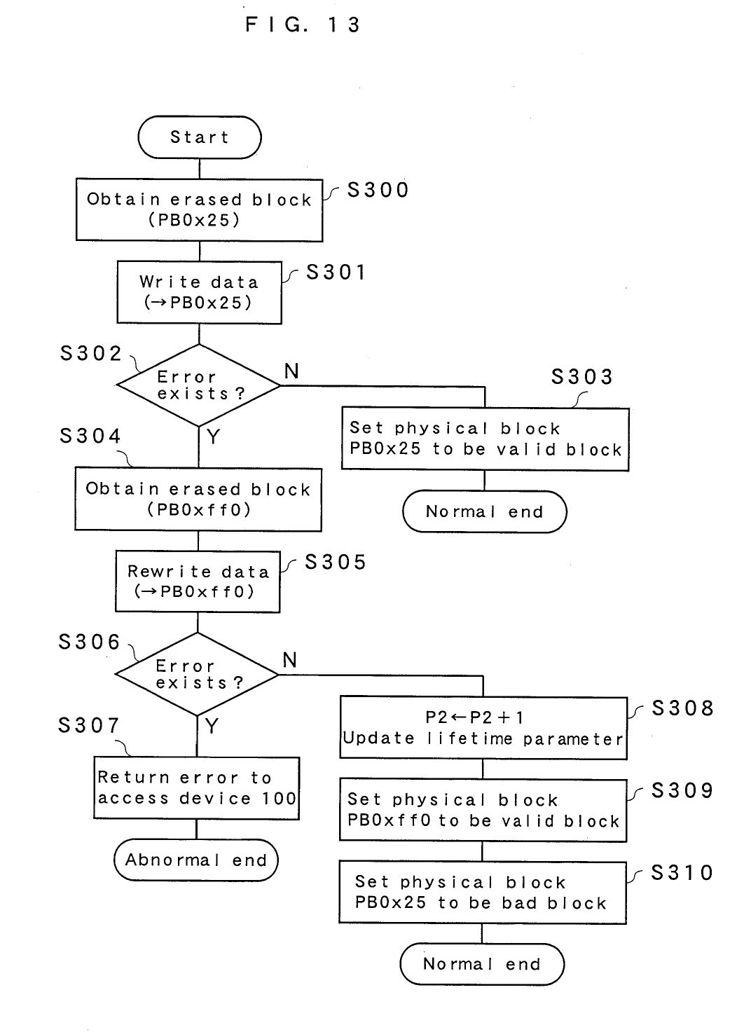

Next, the data writing process in the rewritable mode at S202 and S222 will be explained. Here, a case where the access device 100 writes data of 2 k bytes will be explained including a case where a bad block occurs. A case where data of 2 k bytes is already written to logical block number LBN=0 and data of 2 k bytes is written to the same logical block will be explained as an example. FIG. 12A is an explanation view of a case where no writing error occurs, FIG. 12B is an explanation view of a case where a writing error occurs once, and FIG. 12C is an explanation view of a case where a writing error occurs twice. In addition, FIG. 13 is a flowchart showing an operation thereof.

In FIG. 12A, data of 2 k bytes is written in page 0 of physical block PB0x10. After that, the access device 100 issues a writing command of subsequent 2 kbyte-data to the same logical block address LBN0. The nonvolatile memory device receives the 2 kbyte-data via the host interface 121, and retains the data in the buffer 122. The read-write control part 124 refers to a physical address corresponding to logical block number LBN0 in the internally retained logical-physical conversion table. It is assumued that a physical block number (PBN=16) of physical block PB0x10 is stored to this logical address, a block status at a memory position of PBN=16 in the physical region management table is set to a value 0 that means a valid block.

The read-write control part 124 treats physical block PB0x10 as a former block, obtains one erased block on the basis of the physical region management table, for example, physical block PB0x25 as a current block, and starts the writing.

As shown by an arrow A in FIG. 12A, 2 kbyte-data already recorded to physical block PB0x10 that is the former block is firstly stored to page 0 of physical block PB0x25. Then, the read-write control part 124 transfers 2 kbyte-data temporarily stored in the buffer 122 and a physical address corresponding to page 1 of physical block PB0x25 to the memory interface 123, and newly writes the 2 kbyte-data to page 1 of the physical block PB0x25 via the register 141. An arrow B in FIG. 12A shows this writing. In the storage process A and the writing process B, the read-write control part 124 receives a writing status from the nonvolatile memory 140, and the process normally ends when no error exists.

FIG. 12B and FIG. 12C show a case where an error exists in the writing status. FIG. 12B shows a case where the process normally ended after the rewriting, and FIG. 12C shows a case where an error is informed to the access device 100 after giving up further rewriting because of error occurrence in the rewriting. These processes will be explained referring to the flowchart in FIG. 13. To simplify the description, explanation of the evacuation process is omitted and only the writing will be focused and explained.

As described above, in FIG. 13, the read-write control part 124 obtains erased physical block PB0x25 by referring to the physical region management table (S300), and writes 2 kbyte-data to page 1 of physical block PB0x25 (S301). The control part receives a writing status from the nonvolatile memory 140 after the writing and judges whether or not an error exists (S302). When no error exists, the read-write control part 124 sets a block status of physical block PB0x25 in the physical region management table to be valid, that is, a value 00, registers the physical block number to the designated logical block address in the logical-physical conversion table, and normally ends the process (S303). When an error exists, the read-write control part 124 obtains an erased physical block, for example, PB0xff0 in the spare region 148 by referring to the physical region management table (S304). Then, the control part writes evacuation data to page 0 of physical block PB0xff0 at S305 (arrow C), and writes 2 kbyte-data to page 1. The control part receives the writing status from the nonvolatile memory 140 after the writing and judges whether or not an error exists (S306). When an error exists, the control part informs the access device 100 of the error, and abnormally ends the process (S307). When no error exists, parameter P2 is incremented and each lifetime parameter is updated (S308). Subsequently, the read-write control part 124 sets the block status of physical block PB0xff0 in the physical region management table to be valid, that is, a value 00, and registers the physical block number to a corresponding logical address in the logical-physical conversion table (S309). Moreover, the read-write control part 124 sets the block status of physical block 0x25 in the physical region management table to be a bad block, that is, a value 10,and normally ends the process (S310).

The process at S308 will be explained in detail. At S308, when the read-write control part 124 transfers an increment command of parameter P2 to the lifetime parameter generation part 128, the parameter 2 calculation part 126 reads parameter P2 retained in the lifetime parameter retention block 149, and increments the value by 1. Furthermore, the lifetime parameter processing part 127 updates the second to fifth lifetime parameters on the basis of incremented parameter P2, and writes back the lifetime parameters and parameter P2 to the lifetime parameter retention block 149.

N ext, when the access device 100 feeds a reading command of the lifetime parameter in the lifetime parameter retention block 149 to the nonvolatile memory device 110, the nonvolatile memory device 110 reads data of the lifetime parameter retention block 149 and outputs the data to the access device 100 via the host interface. The access device 100 receives this data at the receiving part 101, and the display circuit 103 displays the transferred lifetime parameter. Meanwhile, parameters P1 and P2, the spare block use rate, the lifetime estimation time parameter, the bad block rate, and the number of spare free blocks are used as the lifetime parameters, and the access device 100 may display all of them or may selectively display them. In addition, the access device 100 may process and display these parameters. Moreover, timing when the access device 100 refers to the lifetime parameter in the lifetime parameter retention block may be arbitrary, for example, timing of the initialization after the starting of the power supply or scheduled timing.

Additionally, when the access device 100 side preliminarily knows information corresponding to parameter P1, namely, information related to the allowable capacity of memory defect on the nonvolatile memory device 110, the access device 100 can recognize lifetime of the nonvolatile memory device 110 by sequentially referring to only parameter P2. In such case, when an occurrence rate of bad block is defined to be 2% on the policy and a capacity of the nonvolatile memory device 110 (for example, 1 G byte) is recognized in the initialization for example, the access device 100 can calculate each lifetime parameter on the basis of the information.

Meanwhile, the memory controller 120 may be internally provided with a nonvolatile memory and a lifetime parameter may be stored in the memory. In addition, the nonvolatile memory 140 may be a nonvolatile memory other than the flash memory, for example, a nonvolatile RAM such as a resistive memory. Moreover, parameter P1 and parameter P2 are parameters employing units of the number of physical blocks, however, any units related to a memory capacity such as the number of pages or the number of bytes can be employed. Furthermore, the display circuit 103 is not necessarily a specific display circuit for displaying only the lifetime parameter. For example, the parameter may be displayed on an LCD monitor of standard equipment, such as in a digital still camera.

A process of the access device 100 after the switching to the write once mode will be explained. In the case of the above-described process at S211, namely, the case where the nonvolatile memory device 110 notifies the access device 100 of the write once mode, the access device 100 stops the writing process and the control circuit 102 in the access device 100 displays on the display circuit 103 that the mode has been switched to the write once mode. A user can recognize that the nonvolatile memory device 110 has been switched to the write once mode. After that, the user can record only important information, for example, data to be permanently stored until all erased blocks are consumed. After the mode is switched to the read only mode when the writing ends, the device can be used as a read only memory card so long. Here, as a method for only recording important information such as the data to be permanently stored, the access device 100 may write data after formatting the nonvolatile memory device 110, namely, erasing all of the normal region, or may order the erasing to a part of region of the normal region without formatting. The user can choose either one of the methods. In any case, the access device 100 shifts to the initialization process immediately after recognizing the switching to the write once mode, and the control circuit 102 formats part of or all regions of the nonvolatile memory device in accordance with the user's choice.

As described above, when the mode switching part 129 determines that the nonvolatile memory device 110 gets closer to the end of its lifetime on the basis of the lifetime parameter related to memory defect generated by the lifetime parameter generation part 128, the nonvolatile memory system shown in the embodiment switches the read-write control mode of the nonvolatile memory device 110 from the rewritable mode to the write once mode and notifies the access device 100 of the switching to the write once mode. In this manner, since being able to recognize the switching to the write once mode, the user can meet the mode change, for example, recording data to be permanently stored to the nonvolatile memory device 110.

In addition, a criterion of lifetime of the nonvolatile memory device 110 is the occurrence rate of memory defect to a capacity of the spare region of the nonvolatile memory 140, however, a ratio of the number of actual rewritings to the guaranteed number of rewritings of the nonvolatile memory 140 may be used as the criterion. However, the guaranteed number of rewritings of the nonvolatile memory is only a guaranteed value and not a value of real ability. The value of real ability greatly varies depending on a type of the nonvolatile memory. For example, there is a nonvolatile memory card able to withstand 100,000 rewritings as the real ability even in a case where the guaranteed number of rewritings is 10,000. Accordingly, in order to switch the mode accurately, it is better for the system to switch the read-write control mode on the basis of the occurrence rate of memory defect as the criterion of lifetime.

Additionally, in a system mounting a nonvolatile memory in a portable audio apparatus body, the access device 100 is a circuit module for access in the portable audio apparatus, and the nonvolatile memory device 110 corresponds to a memory module including the nonvolatile memory in the portable audio apparatus. The present invention may include such embodiment.

### INDUSTRIAL APPLICABILITY

The nonvolatile memory system according to the present invention proposed a method for: enabling determination of lifetime of the nonvolatile memory device; and further automatically switching from the rewritable mode to the write once mode immediately before the end of lifetime, and is beneficial in various nonvolatile memory devices such as a semiconductor memory card, a still image recording-reproducing device and a motion picture recording-reproducing device using this memory device, and a mobile phone.

1. A memory controller which writes data to a nonvolatile memory and reads data from said nonvolatile memory in accordance with an access order from an outside, comprising:
a read-write control part for carrying out read-write control of data to said nonvolatile memory, the read-write control part being provided with a plurality of read-write control modes including: a rewritable mode for reading and writing data from and to an arbitrary address of said nonvolatile memory; and a write once mode for carrying out last writing of data to each physical address,
a lifetime parameter generation part for generating a lifetime parameter related to at least one of an occurrence capacity of memory defect of said nonvolatile memory and a number of memory rewritings of said nonvolatile memory; and
a mode switching part for switching said read-write control mode from the rewritable mode to the write once mode and outputting control mode information to specify the read-write control mode when the lifetime parameter generated by said lifetime parameter generation part exceeds a predetermined threshold value.

2. The memory controller according to claim 1, wherein
said lifetime parameter is at least one of: a ratio of an occurrence capacity of memory defect of said nonvolatile memory to an allowable capacity of memory defect of said nonvolatile memory; an estimated time when the occurrence capacity of memory defect reaches the allowable capacity of memory defect; a ratio of the occurrence capacity of memory defect to a total capacity of said nonvolatile memory; a parameter related to a remaining capacity allowing memory defect; and a ratio of the number of rewritings of the nonvolatile memory to a guaranteed number of rewritings of said nonvolatile memory.

3. The memory controller according to claim 1, wherein
said nonvolatile memory is configured by including a plurality of physical blocks, and
an allowable capacity and an occurrence capacity of memory defect of said nonvolatile memory are in units of a number of physical blocks of said nonvolatile memory.

4. The memory controller according to claim 1, wherein
said mode switching part switches the control mode to a read only mode for enabling only data reading when data have been written to all addresses of said nonvolatile memory in the write once mode.

5. A nonvolatile memory device which writes and reads data in accordance with an access order from an outside, wherein
said nonvolatile memory device comprises:
a nonvolatile memory; and
a memory controller for writing data to said nonvolatile memory and reading data from said nonvolatile memory, and
said memory controller includes:
a read-write control part for carrying out read-write control of data to said nonvolatile memory, the read-write control part being provided with a plurality of read-write control modes including: a rewritable mode for reading and writing data from and to an arbitrary address of said nonvolatile memory; and a write once mode for carrying out last writing of data to each physical address,
a lifetime parameter generation part for generating a lifetime parameter related to at least one of an occurrence capacity of memory defect of said nonvolatile memory and a number of memory rewritings of said nonvolatile memory; and
a mode switching part for switching said read-write control mode from the rewritable mode to the write once mode and outputting control mode information to specify the read-write control mode when the lifetime parameter generated by said lifetime parameter generation part exceeds a predetermined threshold value.

6. The nonvolatile memory device according to claim 5, wherein
said lifetime parameter is at least one of: a ratio of an occurrence capacity of memory defect of said nonvolatile memory to an allowable capacity of memory defect of said nonvolatile memory; an estimated time when the occurrence capacity of memory defect reaches the allowable capacity of memory defect; a ratio of the occurrence capacity of memory defect to a total capacity of said nonvolatile memory; a parameter related to a remaining capacity allowing memory defect; and a ratio of the number of rewritings of the nonvolatile memory to a guaranteed number of rewritings of said nonvolatile memory.

7. The nonvolatile memory device according to claim 5, wherein
said nonvolatile memory is configured by including a plurality of physical blocks, and
an allowable capacity and an occurrence capacity of memory defect of said nonvolatile memory are in units of a number of physical blocks of said nonvolatile memory.

8. The nonvolatile memory device according to claim 5, wherein
said mode switching part switches the control mode to a read only mode for enabling only data reading when data have been written to all addresses of said nonvolatile memory in the write once mode.

9. A nonvolatile memory system having: an access device; and a nonvolatile memory device which writes and reads data in accordance with an access order from said access device, wherein
said nonvolatile memory device comprises:
a nonvolatile memory; and
a memory controller for writing data to said nonvolatile memory and reading data from said nonvolatile memory, and
said memory controller includes:
a read-write control part for carrying out read-write control of data to said nonvolatile memory, the read-write control part being provided with a plurality of read-write control modes including: a rewritable mode for reading and writing data from and to an arbitrary address of said nonvolatile memory; and a write once mode for carrying out last writing of data to each physical address,
a lifetime parameter generation part for generating a lifetime parameter related to at least one of an occurrence capacity of memory defect of said nonvolatile memory and a number of memory rewritings of said nonvolatile memory; and
a mode switching part for switching said read-write control mode from the rewritable mode to the write once mode and outputting control mode information to specify the read-write control mode when the lifetime parameter generated by said lifetime parameter generation part exceeds a predetermined threshold value.

10. The nonvolatile memory system according to claim 9, wherein
said lifetime parameter is at least one of: a ratio of an occurrence capacity of memory defect of said nonvolatile memory to an allowable capacity of memory defect of said nonvolatile memory; an estimated time when the occurrence capacity of memory defect reaches the allowable capacity of memory defect; a ratio of the occurrence capacity of memory defect to a total capacity of said nonvolatile memory; a parameter related to a remaining capacity allowing memory defect; and a ratio of the number of rewritings of the nonvolatile memory to a guaranteed number of rewritings of said nonvolatile memory.

11. The nonvolatile memory system according to claim 9, wherein
said nonvolatile memory is configured by including a plurality of physical blocks, and
an allowable capacity and an occurrence capacity of memory defect of said nonvolatile memory are in units of a number of physical blocks of said nonvolatile memory.

12. The nonvolatile memory system according to claim 9, wherein
said mode switching part switches the control mode to a read only mode for enabling only data reading when data have been written to all addresses of said nonvolatile memory in the write once mode.

13. An access device used by being connected to a nonvolatile memory device having a nonvolatile memory, comprising:
a control part for formatting said nonvolatile memory device after, based on read-write control mode information outputted from said nonvolatile memory device, a read-write control mode specified by said read-write control mode is switched to a write once mode.

14. The access device according to claim 13, wherein
said access device has a display circuit for displaying said read-write control mode information.

15. The access device according to claim 13, including a receiving part for receiving the read-write control mode information and the lifetime parameter outputted from said nonvolatile memory device.

16. The access device according to claim 14, including a receiving part for receiving the read-write control mode information and the lifetime parameter outputted from said nonvolatile memory device.
